(19) United States
(12) Patent Application Publication
(10) Pub. No.: US 2016/0165864 A1
(43) Pub. Date: Jun. 16, 2016

(54) FISHING LURE RETAINER

(71) Applicant: Carter T Morehead, Plattsmouth, NE (US)

(72) Inventor: Carter T Morehead, Plattsmouth, NE (US)

(21) Appl. No.: 14/921,477

(22) Filed: Oct. 23, 2015

Related U.S. Application Data
(60) Provisional application No. 62/067,658, filed on Oct. 23, 2014.

(51) Int. Cl. A01K 85/00

(52) U.S. Cl. CPC A01K 85/00

(57) ABSTRACT

A fishing lure retainer is disclosed which includes a base and a carrier. The base is configured to be removeably coupled to a fishing rod and has an elongated body. The carrier is configured to be removably coupled to the base and includes a bottom a first elongated side extending upward from the bottom of the carrier and a second elongated side extending upward from the bottom of the carrier such that the first and second elongated sides define a region for retaining a fishing lure.

### CROSS-REFERENCE TO RELATED APPLICATION

This application claims priority to U.S. Provisional Patent Application 62/067,658 filed Oct. 23, 2014 the entirety of which is incorporated herein by this reference.

### BACKGROUND

Fishing with a rod and reel has been done for many years. When using a modern rod and reel, fishing line (such as braided line or a monofilament) may be spooled on a reel spool or drum. The fishing line extends from the reel to a tip of the rod and may pass through a number of eyes. At the end of the fishing line, tackle including lures, leaders, hooks, etc., may be attached.

Lures typically include hooks such as single hooks, or even a plurality of treble hooks. The lures also have a coupling point, such as a loop, ring, or other device for being coupled (directly or indirectly) to the fishing line. Directly tying the fishing line to the tackle may be done by one of a variety of knots that vary in complexity.

To allow more easy substitution of lures, swivels may be used. Swivels will typically be tied to the end of the fishing line at one end, and clip to a lure or other piece of tackle at the other. Swivels, while making lure substitution simpler than cutting and tying line, may be detrimental to the “swimming” characteristics of the lure as it is pulled through water. Swivels may also be detrimental to the appearance of the lure which can adversely impact its effectiveness in inducing game fish to strike.

To allow them to quickly change between lures, many sport fishermen will keep multiple rods with different lures ready to use on their boats. This, while expensive, allows for the use of the various lures, all tied directly to the fishing line of their respective rod/reel combinations. Many rods and reels include hook attachment points, such as loops, proximate to the rod handle where one of the hooks of a lure may be coupled to the rod or reel.

One drawback of using the loops on a rod handle is that the hooks are still exposed. In fact, with lures having multiple hooks, one or more may be freely hanging from the lure. This provides an opportunity for hooks to snag boat upholstery, clothing, other tackle, or the fishermen themselves.

Accordingly, there is a need for a device to facilitate simple, on the rod storage of a lure while it is not in use that restricts movement of and/or covers the hooks of a lure.

### BRIEF DESCRIPTION OF THE DRAWINGS

FIG. 1 is a front, left elevation view of a fishing lure retainer positioned on a fish rod.

FIG. 2 is a top, side elevation view of a fishing lure retainer base.

FIG. 3 is a bottom side elevation view of a fishing lure retainer base.

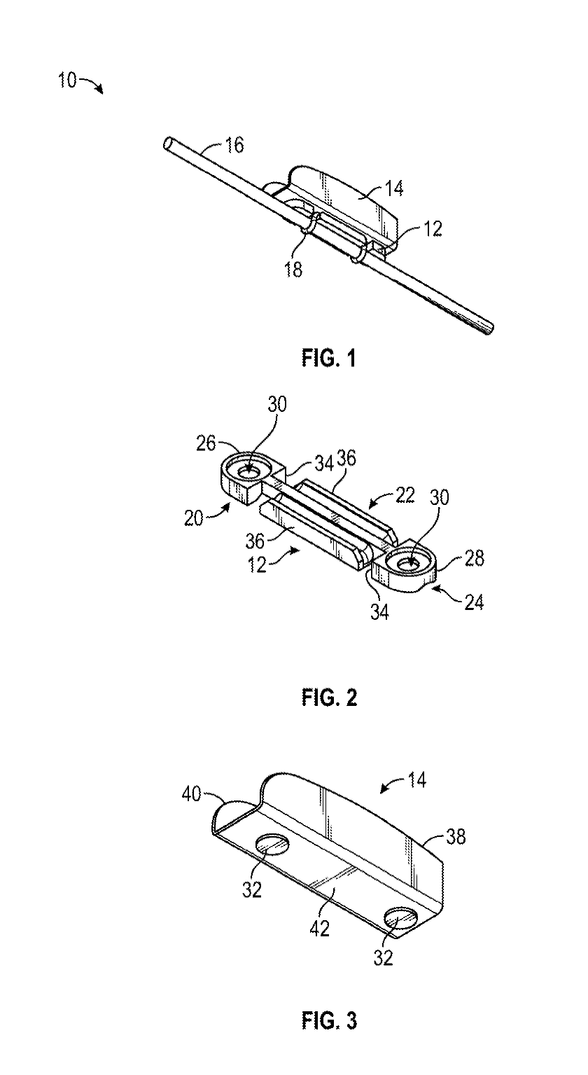

### SUMMARY

The present disclosure relates to a fishing lure retainer which includes a base and a carrier. The base is configured to be removeably coupled to a fishing rod and has an elongated body. The carrier is configured to be removably coupled to the base and includes a bottom a first elongated side extending upward from the bottom of the carrier and a second elongated side extending upward from the bottom of the carrier such that the first and second elongated sides define a region for retaining a fishing lure.

### DETAILED DESCRIPTION

The fishing lure retainer 10 includes a base portion 12 and a carrier portion 14. Fishing lure retainer 10 may be coupled to a fishing rod 16 by way of a coupler 18 shown as an elastomeric band. Alternatively, other sorts of couplers, such as clips, spring loaded levers, or other suitable couplers may be used. Elastomeric bands, however, allow a single coupler to be suitable for a wider range of bas portions and fishing rods. The base portion 12 in generally elongated and has a bottom 20, and a top 22. The bottom includes a groove or channel 24 of a generally semi-circular or arcuate profile configured to engage a portion of rod 16 having a round cross-section. The groove 24 extends generally along a major axis of the base extending between a first end 26 of the base portion 12 and a second end 28. In other embodiments, the bottom of the base may be provided with a soft or compressible material, such as foam, that can conform to the shape of the rod.

As shown, the base portion 12 may be made of plastic or other suitable material. In some embodiments, the base portion 12 may comprise couplers 30 shown as washers or other portions of ferrous metal may be disposed proximate to the first end 26 and the second end 28 to allow coupling the base portion 12 to the carrier 14 by way of couplers shown as magnets 32 positioned on the carrier. Alternatively, a single piece of ferrous metal in the base may be used to, among other things, simplify manufacturing. Placement of the magnets and non-magnetic ferrous pieces on the carrier or the base may be switched. In yet other embodiments, snaps, clips or other devices may be used to removeably couple the carrier and the base by way of a coupler positioned on the top of the base and a mating coupler positioned on the bottom of the carrier.

The base portion 12 may include a plurality of openings 34 provided as opposing pairs as shown. Groves 36 may extend, lengthwise, between openings 34 positioned on the same side of the base portion 12 such that two grooves 36 are provided running parallel to the major axis of the base portion 12. These grooves and openings may accommodate coupler 18 shown as a flexible loop of material such as a rubber band or elastic loop that can be used to secure the base to the rod.

The carrier portion 14 may be generally characterized as an open top receptacle having a generally rectangular bottom and at least two upwardly extending sides 38 and 40. The sides 38 and 40 may be integrally formed with the bottom 42 and made by bending a flat piece of material. The carrier may, optionally, have upwardly extending sides at the front and/or back. The carrier should preferably be sufficiently long to retain the hooks of a lure between the sides 38 and 40.

One or more magnets 32 may be disposed on the bottom of the carrier portion 14. The placement of magnets 32 may correspond to the position of ferrous metal 30 in the base portion 12 to allow removable coupling of the carrier portion 14 to the base portion 12. The magnets 32 serve to retain the lure within the carrier as most fishing hooks include ferrous material that will be attracted to and retained by the magnets 32. This both retains the lure, and hold the hooks within the carrier to avoid snagging or injury.

In use, a number of base portions 12 may be each coupled to a rod 16. A second, perhaps larger, number of carriers may be used to retain each of a plurality of lures. This keeps lures paired with carrier portions of appropriate size also allows the fisherman to tie the lure to the fishing line while the hooks are disposed within the carrier thus reducing the risk of injury from the hooks. A tackle box may be provided with slots configured to receive the carriers holding lures not in use.

Upon selecting a subset of lures to use, the fisherman may tie each of the lures (while still retained in the carrier portion 14) to the fishing line of one of a plurality of rod/reel combinations. After tying the lures on, the carrier, with the lure retained therein, may be coupled to the base portion 12 already positioned near the handle of the rod. Several rods with different lures may be set up in this manner and placed in a boat. This configuration reduces the tension needed to be applied to the fishing line in order to retain a lure to a rod eye or elsewhere which, over time, can damage lures, and deform hooks and eyes.

While fishing, the fisherman may select the rod with the appropriate lure for the water depth, clarity, weather conditions, and species of game fish being targeted. The lure may be easily removed from the carrier portion 14 by separating it from the area near the magnets and the fisherman may begin normal use of the rod/reel combination and lure to fish. To change lures, the fisherman simply places the lure in use in its carrier, takes up the slack in the line, and selects another rod/reel/lure combination.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

The terminology used in the description herein is for the purpose of describing particular embodiments only and is not intended to be limiting of the invention. As used in the description of the embodiments and the appended claims, the singular forms “a”, “an” and “the” are intended to include the plural forms as well, unless the context clearly indicates otherwise.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that relative terms are intended to encompass different orientations of the device in addition to the orientation depicted in the Figures.

Moreover, it will be understood that although the terms first and second are used herein to describe various features, elements, regions, layers and/or sections, these features, elements, regions, layers and/or sections should not be limited by these terms. These terms are only used to distinguish one feature, element, region, layer or section from another feature, element, region, layer or section. Thus, a first feature, element, region, layer or section discussed below could be termed a second feature, element, region, layer or section, and similarly, a second without departing from the teachings of the present invention.

Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required.” Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

The scope of the disclosure is not intended to be limited to the embodiments shown herein, but is to be accorded the full scope consistent with the claims, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims.

What is claimed is:

1. A fishing lure retainer comprising:
a base configured to be removeably coupled to a fishing rod, the base having:
an elongated body having a top, a bottom, a first end, and a second end; and
at least one coupler disposed on the top of the base;
a carrier configured to be removably coupled to the base, the carrier having:
a bottom including at least one mating coupler configured to removeably couple the carrier to the base by way of the coupler disposed on the top of the base;
a first elongated side extending upward from the bottom of the carrier;
a second elongated side extending upward from the bottom of the carrier such that the first and second elongated sides define a region for retaining a fishing lure; and
a base coupler configured to removeably couple the base to a fishing rod.

2. The fishing lure retainer of claim 1 wherein one of the at least one coupler disposed on the top of the base and the at least one mating coupler comprises a magnet.

3. The fishing lure retainer of claim 2 wherein the other of the at least one coupler disposed on the top of the base and the at least one mating coupler comprises ferrous metal.

4. The fishing lure retainer of claim 2 wherein the magnet is further configured to retain at least one hook of a fishing lure when placed within the carrier.

5. The fishing lure retainer of claim 1 wherein the base coupler comprises an elastic material.

6. The fishing lure retainer of claim 1 wherein the base comprises a groove extending generally parallel to the major axis of the base and configured to at least partially receive a fishing rod.
